(19) United States
(12) Patent Application Publication
(10) Pub. No.: US 2012/0160766 A1
(43) Pub. Date: Jun. 28, 2012

(54) TITANIUM OXIDE POROUS PARTICLE FOR BLOOD PURIFICATION, BLOOD PURIFICATION MATERIAL AND MODULE FOR BLOOD PURIFICATION

(75) Inventors: Takafumi IMAIZUMI, Kanagawa (JP); Michio Murayama, Kanagawa (JP)

(73) Assignee: COVALENT MATERIALS CORPORATION, Tokyo (JP)

(21) Appl. No.: 13/335,508

(22) Filed: Dec. 22, 2011

(30) Foreign Application Priority Data
Dec. 28, 2010 (JP) 2010-292226
Sep. 30, 2011 (JP) 2011-216642

(51) Int. Cl. B01D 39/00

(52) U.S. Cl. 210/510.1; 210/500.1

(57) ABSTRACT

The present invention relates to a titanium oxide porous particle for blood purification, which includes a titanium oxide, in which when the titanium oxide porous particle is measured by an electron spin resonance measurement at a temperature of 10 K, a signal at a g value of around 1.96 is present, the signal being divided into two signals representing a component g₁ parallel to a axis of symmetry and a component g₂ vertical to the axis of symmetry, and a signal at a g value of from 2.003 to 2.004 is not substantially present.

### CROSS-REFERENCE TO RELATED APPLICATIONS

This application claims the benefit of Japanese Patent Application No. JP 2010-292226, filed Dec. 28, 2010, and Japanese Patent Application No. JP 2011-216642, filed Sep. 30, 2011. The disclosures of each of which are incorporated by reference herein in their entireties.

### FIELD OF THE INVENTION

The present invention relates to a titanium oxide porous particle for blood purification having the ability to eliminate a toxic substance such as endotoxin and the like contained in liquids such as blood, blood plasma and the like (hereinafter referred to as blood and the like), and a blood purification material and a module for blood purification using the titanium oxide porous particle for blood purification.

### BACKGROUND OF THE INVENTION

As one of the treatments for patients having serious liver function disorders, a treatment by a blood purification method has been carried out which eliminates a toxic substance that becomes the cause of disease, making use of a physicochemical phenomenon or an immune reaction by allowing blood or blood plasma of the patients to contact with an adsorbent.

In such a blood purification method, mainly activated carbon and an anion exchange resin have been conventionally used as the adsorbent, but it cannot be said enough in point of adsorption ability and compatibility with blood and the like, so that development is in progress on the new material of the adsorbent for blood purification.

Recently, a titanium oxide particle excellent in blood compatibility has been proposed as a new adsorbent material. For example, Patent Document 1 describes a titanium oxide for bilirubin adsorption use to which blood plasma is directly contacted, which specifies a blood plasma coagulation factor when contacted with human fresh blood plasma, and has a specific surface area of from 20 m²/g to 80 m²/g, an average pore diameter of from 150 angstrom to 200 angstrom and a pH value of from 6 to 7.5. This titanium oxide has sufficient practical usefulness in terms of the adsorption characteristics and blood compatibility, and can be used as an adsorbent to which the total bilirubin in blood plasma is selectively adsorbed.

In addition, also known is a blood depurative which includes a titanium oxide particulate heat-treated under an non-oxidizing atmosphere, has the ability to eliminate toxic substances in blood and blood plasma and inhibits elimination of useful substances in blood and blood plasma (e.g., see Patent Document 2).

However, in the adsorbent for blood purification described in Patent Document 1, adsorption amount of toxic substances, particularly endotoxin, contained in blood cannot be said sufficient, so that further improvement of adsorption performance is in demand.

In addition, the blood depurative, described in Patent Document 2, has a photocatalyst activity and it cannot necessarily be said that the effects to eliminate toxic substances in blood and the like and to inhibit elimination of useful components are sufficient.

[Patent Document 1] JP-A-2001-245973

[Patent Document 2] JP-A-2005-287701

### SUMMARY OF THE INVENTION

The invention has been made to solve the above-mentioned problems. An object of the invention is to provide a blood purification material which is excellent in adsorption ability of toxic substances contained in blood and the like, while it eliminates useful substances contained in the blood and the like as small as possible, and a module for blood purification using the titanium oxide porous particle for blood purification.

The invention relates to a titanium oxide porous particle for blood purification, which comprises a titanium oxide, wherein when the titanium oxide porous particle is measured by an electron spin resonance measurement at a temperature of 10 K, a signal at a g value of around 1.96 is present, the signal being divided into two signals representing a component g₁ parallel to a axis of symmetry and a component g₂ vertical to the axis of symmetry, and a signal at a g value of from 2.003 to 2.004 is not substantially present.

### BRIEF DESCRIPTION OF THE DRAWINGS

FIG. 1 is a chart showing ESR spectrum of the titanium oxide porous particle regarding Example 1.

FIG. 2 is a chart showing XRD pattern of the titanium oxide porous particle regarding Example 1.

FIG. 3 is a chart showing ESR spectrum of the titanium oxide porous particle regarding Comparative Example 2.

FIG. 4 is a chart showing XRD pattern of the titanium oxide porous particle regarding Comparative Example 2.

FIG. 5 is a graph showing periodical change of albumin concentration in the albumin adsorption evaluation in Examples 1 and 2.

FIG. 6 is a graph showing periodical change of endotoxin concentration in the endotoxin elimination capacity evaluation in Examples 1 and 2 and Comparative Examples 1 and 2.

### DETAILED DESCRIPTION OF THE INVENTION

Since such a titanium oxide porous particle does not have free electrons, photocatalyst activity function is not easy to work so that degradation of useful substances is inhibited and excellent blood purification action is exerted.

The titanium oxide porous particle for blood purification, which preferably exhibits a powder X-ray diffraction pattern having full widths at half maximum of peaks corresponding to plane directions of (002), (310) and (220) of from 0.3° to 0.7°.

The titanium oxide particle having a certain full width at half maximum in the peak of such a specific plane direction is excellent particularly in the adsorption ability of toxic substances contained in blood and the like.

Also, the titanium oxide porous particle for blood purification, which preferably has Ca concentration in a position of at least from a surface to 50 μm or more in depth of from 3000 ppm to 8000 ppm.

Such a titanium oxide porous particle has strength which is excellent in the handling easiness as a blood purification material and can also reduce dusting characteristics.

In addition, the titanium oxide porous particle for blood purification, which preferably exhibits a powder X-ray diffraction pattern including only patterns of TiO₂ (ruffle type) and a small amount of CaTiO₃ (perovskite type).

Since the binding configuration of titanium oxide having such a characteristic has Ca on the surface, it has strength which is excellent in the handling easiness as a blood purification material and can also reduce dusting characteristics.

Also, the invention relates to a blood purification material, which comprises a plurality of said titanium oxide porous particles, which are integrated by sintering.

By such an integrated block shape, the package in a container such as a module for blood purification becomes easy, and also, shedding and dusting of the titanium oxide porous particle can be further reduced.

Moreover, a module for blood purification of the invention, which comprises a plurality of said titanium oxide porous particles, which are preferably packed in a light-resistant container having a light transmittance of 30% or less at a wavelength of from 200 nm to 700 nm.

According to such a module, photocatalyst activity of the titanium oxide porous particle can be inhibited more certainly and degradation of useful substances by the titanium oxide porous particle is inhibited more effectively in carrying out blood purification.

In this connection, as the toxic substances contained in blood and the like according to the invention, there may be mentioned endotoxin, bilirubin, bile acid, ammonia and the like. In addition, as the useful substances, there may be mentioned proteins such as albumin, fibrinogen and the like.

According to the titanium oxide porous particle regarding the invention, it is able to provide a blood purification material which can efficiently eliminate toxic substances contained in blood and the like and also can inhibit reduction of useful substances.

Also, according to the blood purification material regarding the invention, it is easier to handle than the condition of the particles as such, and to reduce shedding and dusting properties.

In addition, according to the module for blood purification regarding the invention, the adsorption ability of toxic substances by the above-mentioned titanium oxide porous particle or blood purification material regarding the invention can be exerted further effectively without causing degradation of useful substances such as proteins.

Accordingly, the titanium oxide porous particle regarding the invention and blood purification material and module for blood purification using the titanium oxide porous particle for blood purification can be applied suitably to a blood purification therapy by extracorporeal circulation such as blood dialysis, plasma exchange, adsorption therapy and the like.

The following describes the invention further in detail.

The titanium oxide porous particle regarding the invention is a titanium oxide, in which when measured by an electron spin resonance (ESR) measurement at a temperature of 10 K, a signal at a g value of around 1.96 is present, this signal is divided into two signals of a component g₁ parallel to the axis of symmetry and a component g₂ vertical thereto, and a signal at a g value of from 2.003 to 2.004 does not substantially exist.

Since such a titanium oxide porous particle has a large number of stable oxygen defects, toxic substance elimination capacity becomes high. Also, being a construction free from free electrons, photocatalyst activity function is not easy to work, degradation of useful substances is inhibited and further, it exerts an excellent blood purification action.

The titanium oxide having such characteristics is different from the existing photocatalyst (hereinafter referred to as visible light type photocatalyst) of anatase type crystalline structure having stable oxygen defect, which shows the activity under visible light irradiation. That is, a signal at a g value of from 2.003 to 2.007, which is known as a signal assigned to the oxygen defect of titanium oxide by ESR, is not substantially observed.

In addition, the titanium oxide porous particle in which the signal the g value assigned to Ti³⁺ shows around 1.96 by ESR shows definite aeolotropy and divided into two signals of a component g₁ parallel to the axis of symmetry and a component g₂ vertical thereto has a large number of stable oxygen defects, but the visible light type photocatalyst activity is inhibited so that it exerts excellent blood purification action.

Particularly, when the range of g₁ is from 1.934 to 1.938, the range of g₂ is from 1.962 to 1.968 and a signal of from 2.003 to 2.004 is not substantially present, the visible light type photocatalyst activity is inhibited and further superior blood purification action is exerted.

On the other hand, when the signal of from 2.003 to 2.004 is present, the photocatalyst activity function is easy to work so that degradation of useful substances becomes easily accelerated.

The titanium oxide porous particle for blood purification, which preferably exhibits a powder X-ray diffraction pattern having full widths at half maximum of peaks corresponding to plane directions of (002), (310) and (220) of from 0.3° to 0.7°.

In the powder X-ray diffraction, the pattern of the titanium oxide to be measured varies depending on not only crystalline structure of the porous particle but also shape and the like of the particle. In general, the peak becomes sharp in the case of a perfect crystal with no defect, but the peak is apt to become broad when there are disorder, defection and the like on the crystallinity.

It is considered that the titanium oxide having a predetermined full width at half maximum in the above-mentioned peak corresponding to specific plane direction has an oxygen deficiency defect at a specific position in the crystalline structure, it is excellent in the adsorption ability of toxic substances contained in blood and the like so that it can be suitably used for blood purification.

When full width at half maximum of peak is less than 0.3°, there is a possibility that the ability to eliminate toxic substances contained in blood and the like is reduced.

On the other hand, when full width at half maximum of peak is larger than 0.7°, there is a possibility that there is a possibility of causing a difficulty in ensuring sufficient contact area with blood and the like because baking must be carried out at such a high temperature that specific surface area becomes markedly small for preparing such a ±titanium oxide particle.

In addition, the titanium oxide porous particle is used as a blood purification material. Ca concentration in a layer of the particle of from the surface to 50 μm or more in depth is preferably from 3000 ppm to 8000 ppm.

Such a titanium oxide porous particle has a strength in which at least the particle surface is excellent in handling easiness as a blood depurative, and it can also reduce dusting characteristics.

The Ca concentration is more preferably from 4500 ppm to 5500 ppm. This enables reliability of breakage resistance in using and handling of the particles to further increase.

On the other hand, when the Ca concentration is less than 3000 ppm or higher than 8000 ppm, there is a possibility that strength of the titanium oxide porous particle is lowered.

Further, it is more preferable that Ca concentration of the particle shows a uniform distribution within a range of ±20 ppm on the whole particle.

This enables reliability of breakage resistance in using and handling of the particles to further increase.

In addition, it is preferable that the titanium oxide porous particle comprises a titanium oxide which does not substantially have an anatase type titanium oxide, in which only the TiO₂ (rutile type) and CaTiO₃ (provskite type) patterns are observed in the powder X-ray diffraction (XRD) patterns.

The binding mode of titanium oxide having such characteristics enables to gain the strength excellent in handling blood purification material easily, and to further lower dusting characteristics.

In addition, in order to further improve the effects, it is more preferable that the CaTiO₃ (provskite type) pattern is present at the strength ratio of about from 1 to 3 when peak strength corresponding to plane direction of (110) of the TiO₂ is regarded as 100.

Shape and size of the titanium oxide porous particle are not particularly limited as long as it can be contacted with blood and the like containing a toxic substance to be eliminated, and it may be a particulate form, a powder form or granular form, or it may be a pellet form or an unstructured mass form.

However, preferred is a spherical particle having almost uniform size, from the viewpoint of bringing out the adsorption ability of toxic substances by the particle uniformly and efficiently.

Particle diameter of the titanium oxide porous particle is preferably from 0.5 mm to 5 mm.

A particle diameter within the above range is more preferable because it can be packed in a container such as a module for blood purification while ensuring desired adsorption ability for the toxic substances contained in blood and the like.

For the purpose of expressing the above effects, it is more preferable that particle diameter of the particle is from 0.8 mm to 1.2 mm.

In addition, it is preferable that the titanium oxide porous particle has a specific surface area of from 0.8 m²/g to 3 m²/g.

This enables to bring out the blood purification action sufficiently and inhibit the degradation of useful substances because adsorption of toxic substances contained in blood and the like can be carried out by sufficiently ensuring the contact area with blood and the like.

It is preferable that porosity of the titanium oxide porous particle is from 25% to 55%.

This enables to obtain adsorption ability of toxic substances contained in blood and the like sufficiently, and to gain the strength enough for preventing dusting in using the titanium oxide porous particle by packing a container such as a module for blood purification.

The titanium oxide itself (titanium oxide material) to be used in the titanium oxide porous particle regarding the invention can be produced, in general, by a sulfuric acid method in which titanium sulfate is hydrolyzed and sintered, a chlorine method in which titanium tetrachloride is oxidized at a high temperature, a sol-gel synthesis method in which a titanium alkoxide compound is treated in an aqueous solution of an acidic or alkaline compound which is volatilized in sintering and the resulting titanium oxide is obtained as a precipitate, and the like.

According to the invention, an appropriate blood purification action can be obtained by using the titanium oxide material prepared by any one of these production methods.

In addition, the titanium oxide porous particle regarding the invention is produced by using the titanium oxide material obtained in the above manner, but the production method is not particularly limited. It can be obtained by pulverizing a sintered body, or also, a granular molded body may be sintered, and for example, it can be suitably produced by the method shown below.

Firstly, a slurry is prepared by putting a calcining powder of titanium oxide into a sodium alginate aqueous solution prepared by adding and mixing a dispersant, and pulverizing and mixing the resulting product. Next, a spherical titanium oxide gel is prepared by adding this slurry dropwise to a calcium chloride aqueous solution and effecting gelation. Thereafter, this spherical titanium oxide gel is washed and dried, treated at a temperature of from 700° C. to 1000° C. and then treated at a temperature of from 800° C. to 1000° C. under a reducing atmosphere such as a hydrogen atmosphere, thereby obtaining a titanium oxide porous particle for blood purification.

Also, it is preferable that the titanium oxide porous particle is made into a blood purification material by integrating a plurality of said particles by sintering.

By making a blood purification material into a block shape through such an integration, the package in a container such as a module for blood purification becomes easy, and contamination of particles and dust into blood and the like to be purified, due to shedding of the titanium oxide porous particle and dusting from the particle surface, can be further inhibited.

The method for obtaining such a block shape blood purification material is not particularly limited, but for example, a blood purification material in which titanium oxide porous particles are integrated can be obtained based on the production method of a titanium oxide porous particle for blood purification exemplified in the above, by a method in which a spherical titanium oxide gel is washed with pure water and dried, and the thus obtained particles are filled in a predetermined mold to effect their integration by applying a load and then subjected to heat treatment in the atmosphere and under the reducing atmosphere in the same manner as the above production method.

As the illustrative method for allowing blood and the like to contact with the titanium oxide porous particle or blood purification material, there are a batch method and a circulation (perfusion) method.

In the batch method, the titanium oxide porous particle is contacted with blood and the like by packing the titanium oxide porous particle or blood purification material in a container having permeability, setting the container into a tank, supplying the blood and the like to be purified to this tank, and then stirring the blood and the like for a predetermined period of time.

In the circulation method on the other hand, by passing blood and the like to be purified through a module for blood purification in which the titanium oxide porous particle or blood purification material is filled in or packed in a container such as a cartridge and the like, the titanium oxide porous particle is allowed to contact with the blood and the like, and the blood and the like discharged from the module is circulated using a pump and the like.

Thus, blood and the like in vitro is purified in the blood purification method which uses the titanium oxide porous particle regarding the invention, and the blood and the like purified by the above method are returned into the body.

Also, it is preferable that the container such as a cartridge and the like filled or packed with the titanium oxide porous particle for blood purification or blood purification material produced in the above manner is used after washing with pure water, drying at 120° C., packing in a module for blood purification and then sterilization-treating with γ ray.

When the titanium oxide porous particle for blood purification regarding the invention or the blood purification material which uses the same is applied to a module for blood purification, it is preferable to use it by packing in a light-resistant container having a light transmittance of 30% or less at a wavelength of from 200 nm to 700 nm.

Since titanium oxide generally has a photocatalyst action at a wavelength region of from ultraviolet ray to visible light, it is preferable to packed it in a container which can block a light of such a wavelength region and to thereby inhibit degradation of a useful substance such as protein and the like caused by the photocatalyst action.

Accordingly, by making a module construction which uses the above container, photocatalyst activity of the titanium oxide porous particle can be inhibited and, in carrying out blood purification by the titanium oxide porous particle, it becomes possible to inhibit degradation of useful substances such as protein and to efficiently adsorb and eliminate toxic substances alone.

It is preferable that the light transmittance is 30% or less, because it may be such a level that the photocatalyst activity of titanium oxide is inhibited when the module for blood purification is used under a general room lamp or natural light. More preferred is 10% or less.

Construction of the light-resistant container is not particularly limited as long as it satisfies such a light transmittance. For example, there may be mentioned a conventionally used colored polypropylene container and the like.

### EXAMPLE

The following illustratively describes the invention based on the examples, but the invention is not restricted by the following examples.

### Example 1

62.5 g portion of titanium oxide particles having a specific surface area of about 72 m²/g prepared by the chlorine method as the titanium oxide material, 250 g of sodium alginate 1 wt % aqueous solution, and 1.8 g of Aron A-30SL (manufactured by TOAGOSEI CO., LTD.) as a dispersant were mixed and put into a pot, and a slurry was prepared by a pot mill using resin balls.

Next, using a perista pump equipped with a fluorine resin tube of 1 mm in inner diameter, this slurry was added dropwise to a 1.2% by weight calcium chloride aqueous solution and allowed to stand still for 8 hours or more to cause sufficient gelation, thereby preparing a spherical titanium oxide gel.

Thereafter, this spherical titanium oxide gel was washed with pure water and dried at 80° C. for 5 hours or more, and then subjected to temperature rising at 200° C./hr in the atmosphere and heat-treated at 1000° C. for 3 hours, thereby obtaining a titanium oxide porous particle.

Further, this titanium oxide porous particle was subjected to temperature rising at 200° C./hr under an atmosphere of hydrogen and heat-treated by keeping at 1000° C. for 2 hours, thereby preparing a titanium oxide porous particle for blood purification.

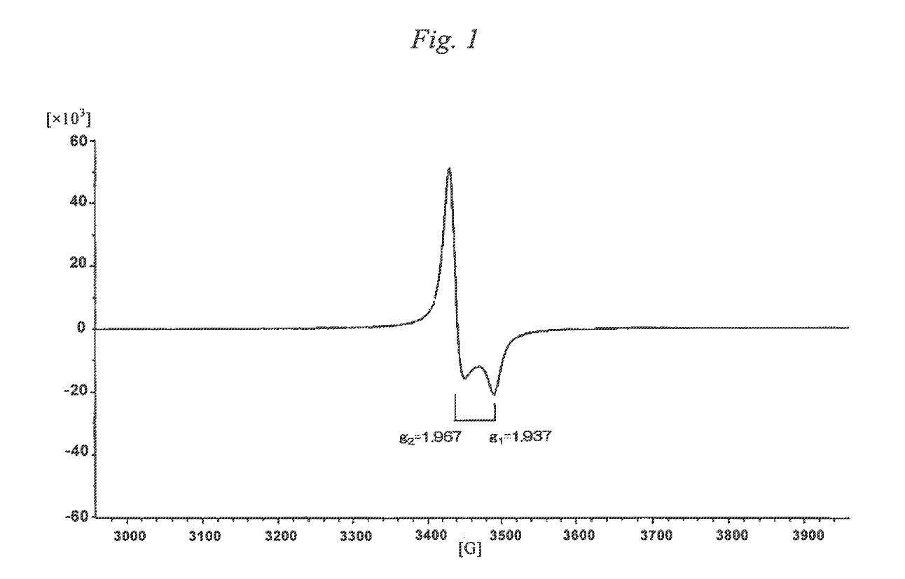

ESR spectrum of the thus prepared titanium oxide porous particle for blood purification was measured by an electron spin resonance analyzer ESP350E (manufactured by BRUKER) at a temperature of 10K. The measured spectrum is shown in FIG. 1.

As shown in FIG. 1, anisotropy of g value was clearly observed, Ti³⁺ showed a spectral pattern characteristic to the axially symmetric ligand field and the two main values of the g value (component g₁ parallel to the axial symmetry and component g₂ vertical thereto) were measured to be g₁=1.937 and g₂=1.967, respectively.

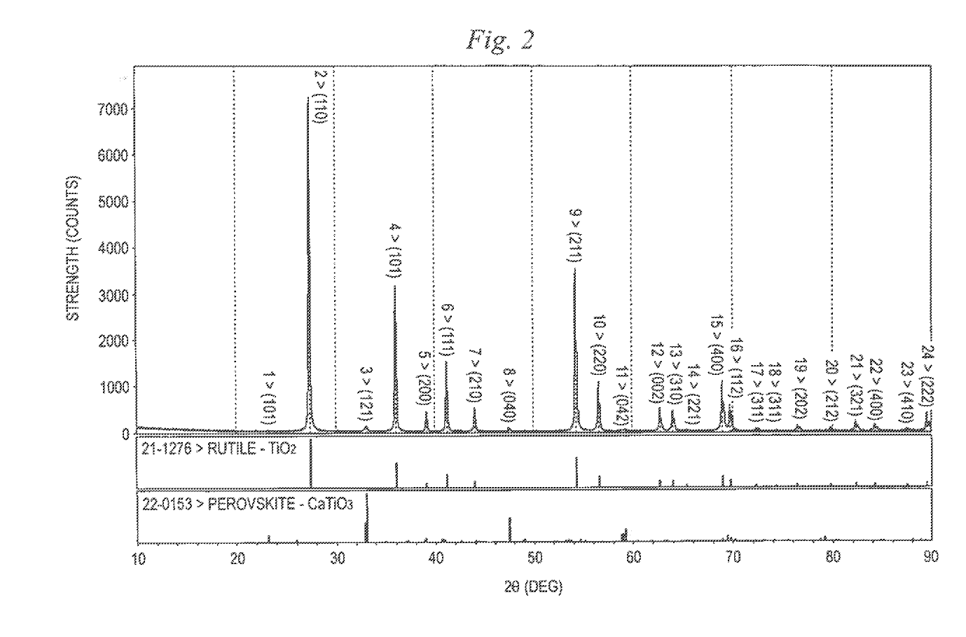

Also, XRD pattern of the titanium oxide porous particle for blood purification was measured by a powder X-ray diffraction analyzer RINT 2000 Vertical Type (manufactured by Rigaku Corporation). The measured XRD pattern is shown in FIG. 2.

As a result of identifying the XRD pattern shown in FIG. 2, only patterns of only TiO₂ (rutile type) and CaTiO₃ (perovskite type) were measured. In the XRD pattern measured above, full widths at half maximum of peaks corresponding to plane directions of (002), (310) and (220) of the titanium oxide porous particle for blood purification were 0.402°, 0.352° and 0.333°.

Also, it was confirmed that strength ratio of the CaTiO₃ (perovskite type) pattern was 2.6 when the peak strength corresponding to plane direction of (110) of TiO₂ was regarded as 100.

In addition, average pore size of titanium oxide porous particle for blood purification was 0.28 μm. This average pore size was regarded as the pore diameter peak value calculated by measuring pore diameter distribution by a mercury porosimeter (Autopore 9500 manufactured by Micromeritics).

Also, its specific surface area was 2.28 m²/g when measured by a BET specific surface area meter (ASAP 2020, manufactured by Micromeritics).

Further, when particle diameter was measured by image analysis of 300 particles, it was from 1.05 to 1.17 mm.

In addition, Ca concentration of the titanium oxide porous particle for blood purification in a position of from the surface to 50 μm or more in depth was 4990 ppm. This Ca concentration was calculated by degrading the titanium oxide porous particle for blood purification to a position of 50 μm or more in depth with sulfuric acid and hydrofluoric acid and measuring by an ICP emission analyzer VISTA-PRO (manufactured by Seiko instruments Inc.).

Further, 10 samples of the titanium oxide porous particle were collected and Ca concentrations of the central part (inside a concentric circle of 50 μm in radius directing from the central point toward the peripheral part) and peripheral part (within 50 μm in depth directing from the outer surface toward the central point) of each particle were measured. Thereafter, when average Ca concentration in each titanium oxide porous particle was calculated, it was found that it showed a uniform distribution within a rage of ±20 ppm in the each whole particle.

### Example 2

The spherical titanium oxide gel prepared in Example 1 was washed, dried and then filled in a cylindrical mold and particles were integrated by applying a load thereto from the upper side, thereby preparing a columnar shape spherical titanium oxide molded body.

This columnar shape spherical titanium oxide molded body was subjected to a temperature rising at 200° C./hr in the atmosphere and treated at 1000° C. for 3 hours to obtain a titanium oxide porous particles-integrated cylindrical shape block body of 14.7 mm in diameter and 88 mm in height.

Further, this block body prepared by integrating titanium oxide porous particles was subjected to a temperature rising at 200° C./hr under an atmosphere of hydrogen and heat-treated by keeping it at 1000° C. for 2 hours, thereby preparing a blood purification material in which titanium oxide porous particles for blood purification were integrated.

In the same manner as in Example 1, respective valuation measurements were carried out on the titanium oxide porous particle of thus prepared blood purification material.

ESR spectrum and XRD pattern of this titanium oxide porous particle were similar to the cases of Example 1 (FIG. 1 and FIG. 2).

Also, full widths at half maximum of peaks corresponding to plane directions of (002), (310) and (220) of the titanium oxide porous particle were 0.46°, 0.356° and 0.359°.

Also, it was confirmed that strength ratio of the CaTiO₃ (perovskite type) pattern was 2.6 when the TiO₂ plane direction (110) peak strength was regarded as 100.

Further, Ca concentration of the titanium oxide porous particle in a position of from the surface to 50 μm or more in depth was 4700 ppm.

### Comparative Example 1

A 100 g portion of titanium oxide particles having a specific surface area of about 72 m²/g prepared by the chlorine method as the titanium oxide material, 150 g of pure water and 3 g of Aron A-30SL (manufactured by TOAGOSEI CO., LTD.) as a dispersant were mixed and put into a pot, and a slurry was prepared by a pot mill using resin balls.

The thus obtained slurry was dried at room temperature and then subjected to a temperature rising at 200° C./hr and subjected to a heat treatment at 705° C. for 2 hours in the atmosphere. The thus obtained sintered body was pulverized and classified into a particle diameter of from 0.5 mm to 1.2 mm.

Further, by carrying out a temperature rising at 200° C./hr and keeping at 705° C. for 2 hours in the under an atmosphere of hydrogen, a titanium oxide porous particle for blood purification was prepared.

In the same manner as in Example 1, respective evaluation measurements were carried out on the thus prepared titanium oxide porous particle for blood purification.

As a result of measuring ESR spectrum, anisotropy of g value was not clearly observed and Ti³⁺ did not show a spectral pattern characteristic to the axially symmetric ligand field.

Also, as a result of identifying XRD pattern, patterns of TiO₂ (rutile type and anatase type) and CaTiO₃ (perovskite type) were measured.

In addition, average pore size of titanium oxide porous particle for blood purification was 0.04 μm and specific surface area thereof was 48.2 m²/g.

### Comparative Example 2

The spherical titanium oxide gel prepared in Example 1 was washed and dried and then subjected to a temperature rising at 200° C./hr in the atmosphere and heat-treated at 1000° C. for 3 hours to obtain a titanium oxide porous particle.

Further, this titanium oxide porous particle was subjected to a temperature rising at 200° C./hr under an atmosphere of hydrogen and then to a heat treatment by keeping it at 700° C. for 2 hours, thereby preparing a titanium oxide porous particle for blood purification.

On the thus prepared titanium oxide porous particle for blood purification, respective evaluation measurements were carried out in the same manner as in Example 1.

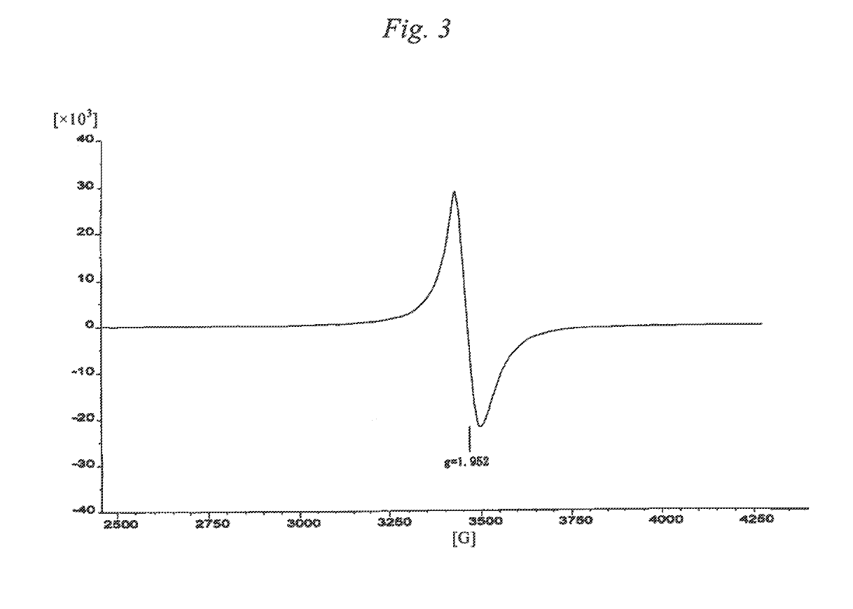

The measured ESR spectrum is shown in FIG. 3.

As shown in FIG. 3, anisotropy of the g value was not clearly observed and Ti³⁺ did not show a spectral pattern characteristic to the axially symmetric ligand field.

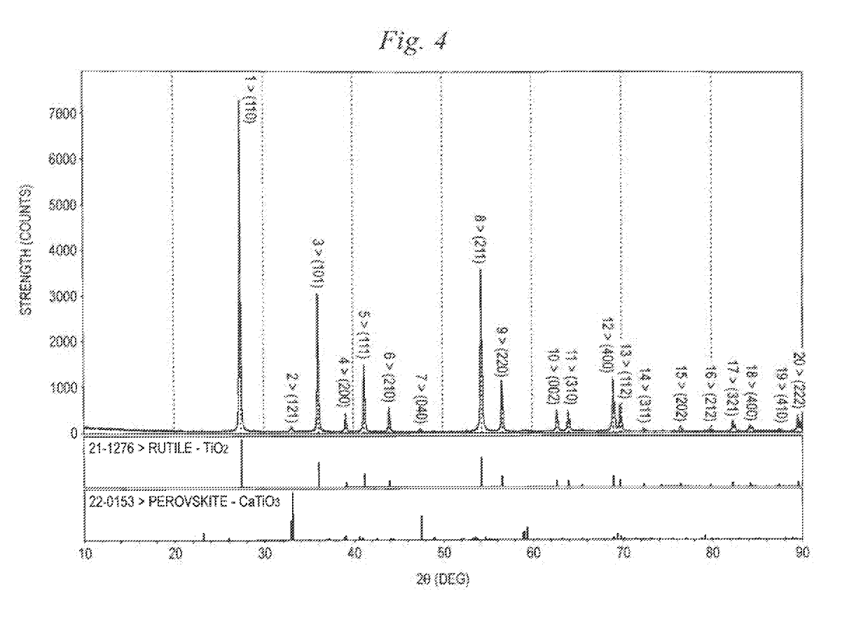

Also, the measured XRD pattern is shown in FIG. 4.

As a result of identifying the XRD pattern shown in FIG. 4, only the patterns of TiO₂ (rutile type) and CaTiO₂ (perovskite type) were measured.

Also, in the XRD patterns measured in the above, full widths at half maximum of peaks corresponding to plane directions of (002), (310) and (220) of the titanium oxide porous particle for blood purification were 0.203°, 0.221° and 0.184°.

Also, it was confirmed that strength ratio of the CaTiO₃ (perovskite type) pattern was 1.7 when the peak strength of TiO₂ plane direction (110) was regarded as 100.

In addition, average pore size of the titanium oxide porous particle for blood purification was 0.22 μm, specific surface area thereof was 2.48 m²/g and particle diameter thereof was from 1.05 mm to 1.17 mm.

Further, Ca concentration of the titanium oxide porous particle for blood purification in a position of from the surface to 50 μm or more in depth was 4900 ppm.

### Example 3

A titanium oxide porous particle for blood purification was prepared in the same manner as in Example 1, except that the sodium alginate aqueous solution to be added in preparing the slurry in Example 1 was changed to 1.8 wt %, 250 g.

On the thus prepared titanium oxide porous particle for blood purification, respective measurements were carried out in the same manner as in Example 1.

As a result of measuring ESR spectrum, anisotropy of the g value was clearly observed, and Ti³⁺ showed a spectral pattern characteristic to the axially symmetric ligand field and measured to be g₁=1.937 and g₂=1.967.

Also, as a result of identifying XRD patterns, patterns of TiO₂ (rutile type and anatase type) and CaTiO₃ (perovskite type) were measured.

In addition, full widths at half maximum of peaks corresponding to plane directions of (002), (310) and (220) of the titanium oxide porous particle for blood purification were 0.402°, 0.352° and 0.333°.

Further, it was confirmed that strength ratio of the CaTiO₃ (perovskite type) pattern was 4.0 when the peak strength of TiO₂ plane direction (110) was regarded as 100.

In addition, average pore size of the titanium oxide porous particle for blood purification was 0.28 μm, specific surface area thereof was 2.28 m²/g and particle diameter thereof was from 1.05 mm to 1.17 mm.

Further, Ca concentration of the titanium oxide porous particle for blood purification in a position of from the surface to 50 μm or more in depth was 9600 ppm.

### (Evaluation of Albumin Adsorption Ability)

Modules for blood purification were prepared by packing the titanium oxide porous particle for blood purification prepared in Example 1 and blood purification material prepared in Example 2 respectively in containers having 15 mm in diameter and 90 mm in height. Also, from the viewpoint of safety, handling ability and the like, a polypropylene container having a light transmittance of 25% or less at a wavelength of from 200 nm to 700 nm was used as the module for blood purification.

A circulation circuit was prepared by arranging a silicon tube and a circulation pump on this module.

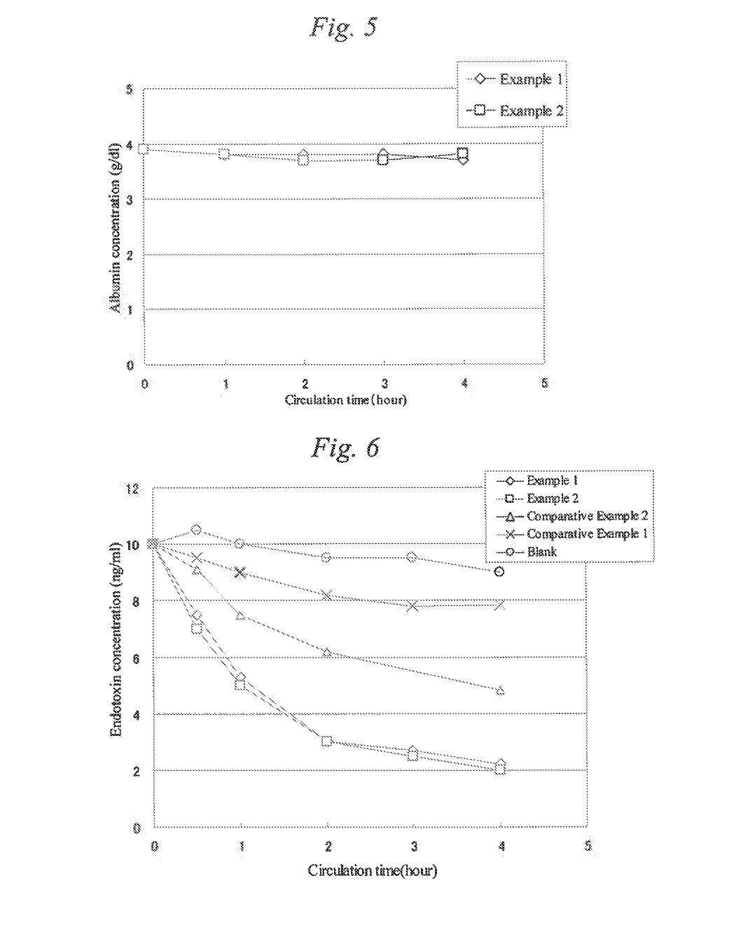

Thereafter, 60 ml of bovine blood plasma was circulated through this circuit at a flow rate of 18 ml/min for 4 hours, and periodical change in the albumin concentration was measured. Shown in FIG. 5 is a graph of periodical changes in the albumin concentration on Examples 1 and 2.

It was confirmed from the results shown in FIG. 5 that the titanium oxide porous particle for blood purification prepared in Example 1 and the blood purification material prepared in Example 2 do not eliminate albumin which is a useful substance.

### (Evaluation of Endotoxin Elimination Ability)

Using the titanium oxide porous particles for blood purification prepared in Example 1 and Comparative Examples 1 and 2 and the blood purification material prepared in Example 2, modules for blood purification were prepared, and circulation circuits were prepared, in the same manner as the case of the above-mentioned albumin adsorption capability evaluation.

By passing 3 liters of physiological saline through each circuit at a flow rate of 100 ml/min, the circuit and clarification material were washed. Thereafter, 60 ml of fetal bovine serum added with endotoxin (derived from E. coli 0111B4, Wako Pure Chemical Industries, Ltd.) was circulated through this circuit at a rate of 15 ml/min and, by collecting the solution at a certain interval, periodical change of the endotoxin concentration was measured (measuring apparatus: Toxinometer ET301, measuring reagent: Limulus, ES-11 Single Test Wako manufactured by Wako Pure Chemical Industries, Ltd.). Shown in FIG. 6 is a graph of periodical changes in endotoxin concentration on Examples 1 and 2, Comparative Examples 1 and 2 and a module not packed with the adsorption material (Control).

From the results shown in FIG. 6, it was confirmed that the titanium oxide porous particle for blood purification prepared in Example 1 and the blood purification material prepared in Example 2 have high endotoxin elimination capacity.

### (Evaluation of Compressive Strength)

Compressive strength of the titanium oxide porous particles for blood purification prepared in Examples 1 and 3 was evaluated by the measurement of breaking load.

As a result of collecting 30 samples for each case and measuring average breaking load using Shimadzu Autograph AG2000C, Example 1 was 42.8 N and Example 3 was 28.0 N.

Based on this, it was confirmed that breaking load of Example 1 is large and compressive strength thereof is high.

1. A titanium oxide porous particle for blood purification, which comprises a titanium oxide, wherein when the titanium oxide porous particle is measured by an electron spin resonance measurement at a temperature of 10 K, a signal at a g value around 1.96 is present, the signal being divided into two signals representing a component g₁ parallel to a axis of symmetry and a component g₂ vertical to the axis of symmetry, and a signal at a g value of from 2.003 to 2.004 is not substantially present.

2. The titanium oxide porous particle for blood purification according to claim 1, which exhibits a powder X-ray diffraction pattern having full widths at half maximum of peaks corresponding to plane directions of (002), (310) and (220) of from 0.3° to 0.7°.

3. The titanium oxide porous particle for blood purification according to claim 1, which has Ca concentration in a position of at least from a surface to 50 μm or more in depth of from 3,000 ppm to 8,000 ppm.

4. The titanium oxide porous particle for blood purification according claim 1, which exhibits a powder X-ray diffraction pattern including only patterns of TiO₂ (rutile type) and a small amount of CaTiO₃ (perovskite type).

5. A blood purification material, which comprises a plurality of said titanium oxide porous particles according to claim 1, which are integrated by sintering.

6. A module for blood purification, which comprises a plurality of said titanium oxide porous particles according claim 1, which are packed in a light-resistant container having a light transmittance of 30% or less at a wavelength of from 200 nm to 700 nm.

7. A module for blood purification, which comprises the blood purification material according to claim 5 packed in a light-resistant container having a light transmittance of 30% or less at a wavelength of from 200 nm to 700 nm.

8. The titanium oxide porous particle for blood purification according to claim 2, which has Ca concentration in a position of at least from a surface to 50 μm or more in depth of from 3,000 ppm to 8,000 ppm.
